(19) United States
(12) Patent Application Publication
(10) Pub. No.: US 2010/0196678 A1
(43) Pub. Date: Aug. 5, 2010

(54) METHOD OF MANUFACTURING A LAMINATE PANEL, AN APPARATUS AND A LAMINATE PANEL

(75) Inventor: Bruno Paul Louis Vermeulen, Aldeneik-Maaseik (BE)

Correspondence Address: WESTMAN CHAMPLIN & KELLY, P.A., SUITE 1400, 900 SECOND AVENUE SOUTH, MINNEAPOLIS, MN, 55402, US

(73) Assignee: Spanolux N.V. -Div .Balterio, Sint-Baafs-Vijve (BE)

(21) Appl. No.: 12/697,571

(22) Filed: Feb. 1, 2010

(30) Foreign Application Priority Data
Jan. 30, 2009 (EP) 09151785.4

(51) Int. Cl. B32B 3/10; B32B 38/14; B32B 38/00; B32B 38/06; B32B 43/00

(52) U.S. Cl. 428/195.1; 156/277; 156/64; 156/219; 156/388

(57) ABSTRACT

A method of manufacturing a laminate panel comprises the steps of providing a support panel having at least one side to be decorated and applying an overlay on said side of the support panel. A finishing decoration pattern is printed on the support panel and/or the overlay by a printing device which is substantially free of contact with the support panel and/or the overlay, respectively.

### BACKGROUND

The discussion below is merely provided for general background information and is not intended to be used as an aid in determining the scope of the claimed subject matter. Laminate panels imitating stone, wood or the like, for example for flooring, are known in the art. A traditional method of manufacturing such a laminate panel comprises the steps of supplying a support panel having one side to be decorated and applying a layer on that side. The layer may be a decoration layer, for example an impregnated paper sheet which is provided with a decoration pattern. The impregnated paper sheet and the support layer are put on each other and joined by using a heated press. Furthermore, for protection of the laminate panel a top layer comprising anti-wear particles is often applied on the decoration layer. The decoration layer and/or the top layer can be provided with a decoration pattern which is often printed on long paper sheets by printing drums, after which the sheets are impregnated with a resin. A disadvantage of the known method is that the costs are relatively high and that the printed sheets require space in stock.

Furthermore, it is desired to imitate natural materials still better. This requires a greater extent of variation of decorative patterns. A possible method for manufacturing such panels is disclosed in WO 2008/040760 of the same applicant as the current application, resulting in an increasingly number of apparently different panels.

WO 99/09274 discloses a method for the production of floor covering elements which comprise an upper face sheet, a decorative layer, a support plate and a lower sheet. The decorative layer may be integrated in the support plate or in the upper face sheet before laminating, such that the number of layers to be laminated is reduced, but it does not eliminate the above-mentioned disadvantage.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

A method according to an aspect of the invention includes providing a support panel having at least one side to be decorated, applying an overlay on said side of the support panel, wherein a finishing decoration pattern is printed on the support panel and/or the overlay by a printing device which is substantially free of contact with the support panel and/or the overlay, respectively.

The advantage of the method is that it allows printing techniques which do not need conventional fixed print pressing techniques, such as using printing drums. Conventional printing presses are expensive and applicable for printing a single type of decoration pattern and therefore the minimal amount of products to be manufactured in terms of cost effectiveness must be relatively high. This may also lead to a relatively high required stock space. When printing is performed just before laminating, the method does not require a stock of printed sheets. This is particularly advantageous if a low amount of panels having a certain pattern is necessary.

Besides, by applying the method, impregnated sheets and/or sheets provided with anti-wear particles for forming a protective top layer can be printed as well since there is no contact between print heads of the printing device and the surface to be printed on. In practice, a protective layer may comprise a paper sheet impregnated with a resin which contains anti-wear particles.

The printing device may comprise a digital printer. The ink of such a printer is transferred to the upper surface of the surface to be printed such that the ink remains on the surface rather than penetrating into the material below the surface such as in case of press printing. Furthermore, a digital printer can be controlled in a flexible way such that a pattern to be printed can be changed very quickly, which is a great advantage compared to conventional printing drums. Typical pattern repetitions, such as in case of a printing drum, can be avoided. It is also possible to print additional information as desired by a client, for example a company logo or the like. Numerous variations in patterns, discontinuous repetition, multi color synchronously with other patterns (for example on the support panel) or not, oil or wax patterns are conceivable. Under operating conditions print heads of a digital printer may be located at a distance of about 0.5-2.5 mm from the surface to be printed on. In case of printing a pattern on a paper which is provided with anti-wear particles this is sufficiently spaced from the surface to be printed on since anti-wear particles may be 30-200 μm, for example. Therefore, the printing device will not deteriorate due to contact with anti-wear particles, which typically happens in case of press printing.

In one embodiment, the finishing decoration pattern is printed on the overlay, and the overlay is impregnated with a resin before or after printing. This means, for example, that a blank paper sheet can be impregnated and dried and then supplied to the printing device, which prints ink on the impregnated sheet without contacting it.

In a practical embodiment, a basic decoration pattern is applied on the support panel, wherein the basic decoration pattern is different from the finishing decoration pattern. This creates a higher degree of variation in decoration appearance of the decoration side of the panel.

In practice the basic decoration pattern may be provided on a decoration layer which is applied on the side of the support panel to be decorated. The basic decoration pattern may be printed on a decoration layer of paper sheet by conventional press printing, impregnated with a resin and laminated to the support panel by heat pressing. It is also possible to print the finishing decoration pattern on the support panel on which a decoration layer having a basic decoration pattern is already applied.

The finishing decoration pattern to be printed on the overlay may be selected on the basis of the basic decoration pattern which is detected by a detector before printing the finishing decoration pattern on the overlay. This provides the opportunity to create a relationship between the basic decoration pattern and the finishing decoration pattern, and to adjust this relationship, possibly automatically. The detector may comprise cameras, for example. In this case there may also be an adjusting device for positioning the finishing decoration pattern and the basic decoration pattern with respect to each other.

A predetermined pattern may be printed on a carrier with curable liquid so as to form an embossing decoration pattern on the carrier, wherein the embossing decoration pattern of the carrier is pressed on the overlay at the side of the support panel to be decorated for creating an embossed surface thereon. This is advantageous in comparison with fixed press plates or press drums comprising an embossed surface since the change of an embossing pattern is less time consuming, whereas there is no need of having a series of different press plates in stock. Furthermore, due to a quick change of embossing pattern the stand-still period of the press is relatively short, thereby reducing the risk of cooling down of a heated press. It is noted that this step of the method can be applied separately from printing a finishing decoration pattern on the overlay or the support panel.

The carrier may be provided from a roller and guidable along a press plate. This provides a fast performance of the method.

An aspect of the invention is also related to an apparatus for manufacturing a laminate panel by a method as described hereinbefore.

An aspect of the invention is also related to a laminate panel manufactured by a method as described hereinbefore.

It is noted that a decoration pattern may be a pattern in terms of color, material appearances such as wood grains, knots, gloss, surface treatments, logos or the like.

### BRIEF DESCRIPTION OF THE DRAWINGS

Aspects of the invention will be explained in more detail hereinafter with reference to drawings, which are very schematic representations of embodiments of the invention.

FIG. 1 is a schematic side view of an embodiment of the apparatus.

FIG. 2 is a top view of two panels having similar basic decoration patterns, but different finishing decoration patterns.

FIGS. 3a and 3b are a side view and plan view, respectively, of an alternative embodiment of the apparatus of FIG. 1.

FIG. 4 is a similar view as FIG. 1 of another alternative embodiment.

FIG. 5 is an illustration of scanning a pressed panel and controlling a saw on the basis of the scanned information.

### DETAILED DESCRIPTION OF THE ILLUSTRATIVE EMBODIMENTS

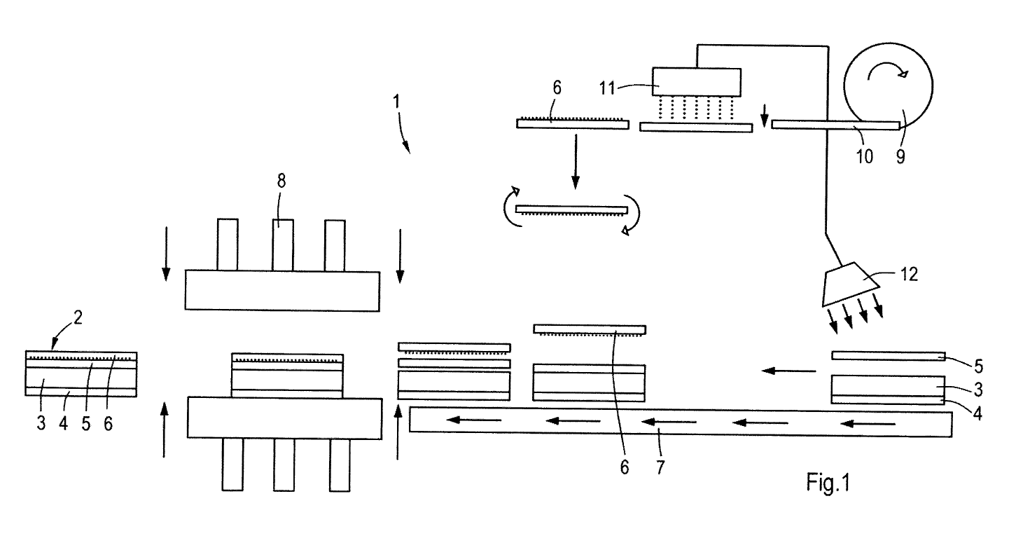

FIG. 1 shows an embodiment of an apparatus 1 for manufacturing a laminate panel 2. The laminate panel 2 comprises a support panel 3, a balancing layer 4, a decoration layer 5 and an overlay 6. Alternative laminate panels 2 may comprise more or less layers 4-6. The support panel 3 may be a wood-based material like MDF or HDF, but alternative materials are conceivable, as well.

The apparatus 1 typically includes a system controller, not shown. As is known in the art, such a system controller can be embodied using one or more analog and/or digital computers. The system controller is operably coupled to provide outputs control signals to the components described below to form laminate panels 2 in the manner described below and having the features described below. The system controller generates the control signals based typically on a stored program (e.g. computer instructions stored on a computer readable medium and executable by a processor) for forming such laminate panels, and further based on inputs from detectors described below and other suitable sensors monitoring other parameters of the process of forming such laminate panels such as but not limited to the position of elements in the apparatus 1 used to form the laminate panels and the status of the components described below.

FIG. 1 shows a conveyor 7 on which the support panel 3 and the layers 4-6 are placed onto each other and by which the support panel 3 and the layers 4-6 are moved towards a press 8. In case the balancing layer 4, the decoration layer 5 and the overlay 6 are paper sheets impregnated with a resin and dried afterwards, the press 8 is heated such that the layers 4-6 are fixed to each other and to the support panel 3 by heat pressing.

The decoration layer 5 is provided with a basic decoration pattern, in this case printed on a paper sheet and provided in separate pieces having substantially the same dimensions as the support panel 3.

The apparatus 1 further comprises a paper sheet roller 9 for supplying a blank paper sheet 10 to a digital printer 11. The digital printer 11 is able to print a predetermined finishing decoration pattern onto the paper sheet 10. The digital printer 11 differs from conventional press printing in that a print head thereof does not contact the paper sheet 10 during printing. The printed paper sheet 10 forms the overlay 6 and may be cut before or after printing.

As illustrated in FIG. 1 the apparatus 1 is provided with a detection apparatus 12 which in effect communicates electronically with the digital printer 11. In this embodiment the detection apparatus 12, which may be a camera, scans the basic decoration pattern of the decoration layer 5. On the basis of the recognized basic decoration pattern the digital printer 11 can print a certain finishing decoration pattern on the paper sheet 10. In a next step, the paper sheet 10, which may have been cut earlier into a separate sheet having substantially the same dimensions as the support panel 3, can be turned upside down and placed onto the decoration layer 5 using known sheet handling machines. This is illustrated in FIG. 1. The paper sheet 10 forms an overlay 6 on the top of a stack comprising the balancing layer 4, support panel 3 and decoration layer 5. The material of the paper sheet 10 will be selected such that it becomes substantially transparent after manufacturing the laminate panel 2 so as to enable a person to see the basic decoration pattern of the decoration layer 5 after finishing the manufacturing of the laminate panel 2. In practice the overlay 6 may be provided with anti-wear particles at the side on which the finishing decoration pattern is printed (the upper side in FIG. 1). After turning the paper sheet 10 upside down, the anti-wear particles are disposed at the side of the overlay 6 facing to the support panel 3, but the anti-wear particles are still at the top of the decoration layer 5 so as to protect this layer 5. This means that in the press 8 the anti-wear particles will have less adverse effect on the press plate during pressing. Due to contactless or digital printing by the digital printer 11, the anti-wear particles will not damage the print heads of the digital printer 11.

The paper sheet 10 may be impregnated with a resin before or after printing the finishing decoration pattern.

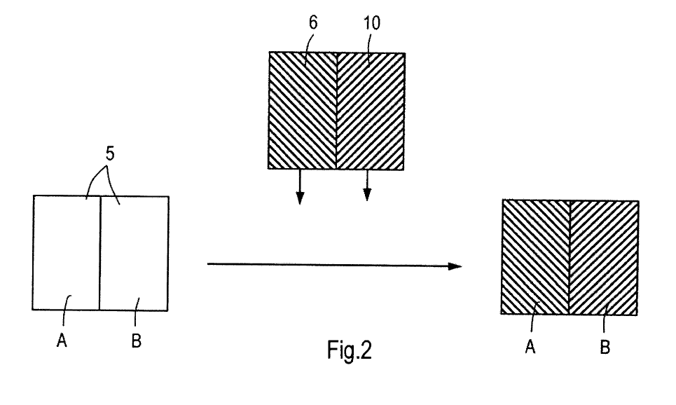

One of the numerous possible laminate panels 2 that can be manufactured with the apparatus 1 is schematically illustrated in FIG. 2. Panels A and B have a decoration layer 5 including a basic decoration layer pattern. The basic decoration patterns of both panels A and B may be similar. The overlay 6 or paper sheet 10 is printed such that the finishing decoration pattern thereof is different at the portion intended to cover panel A with respect to the portion intended to cover panel B. For example, panel A may have a finishing decoration pattern imitating a waxed surface, whereas panel B may have a finishing decoration pattern imitating an oiled pattern. This may create different appearances of panels A and B, whereas the basic decoration pattern of both panels A and B is similar. Because of the flexibility of digital printing, a lot of variations are conceivable.

In practice, the finishing decoration pattern and the basic decoration pattern may be different but the patterns may also be complementary to each other. The digital printer 11 provides the opportunity to create a great variability in patterns and repetitions thereof.

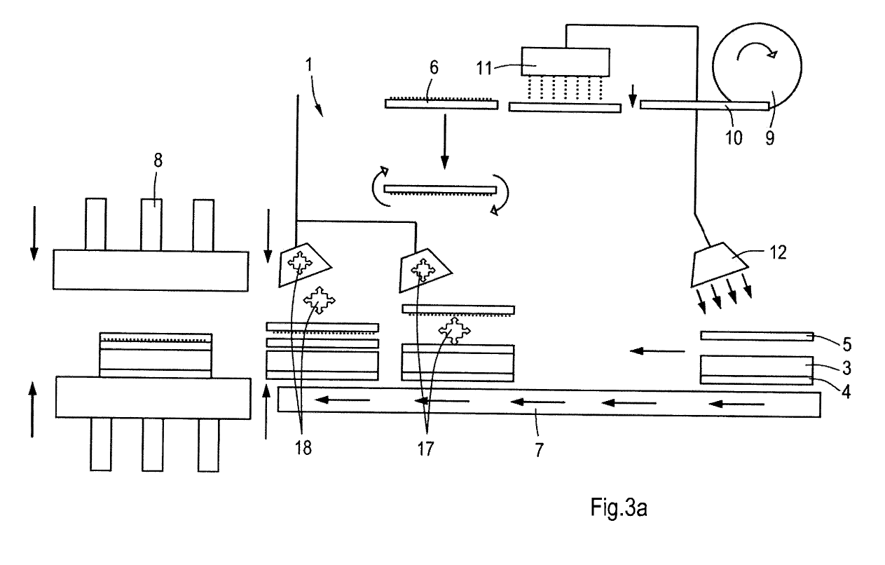

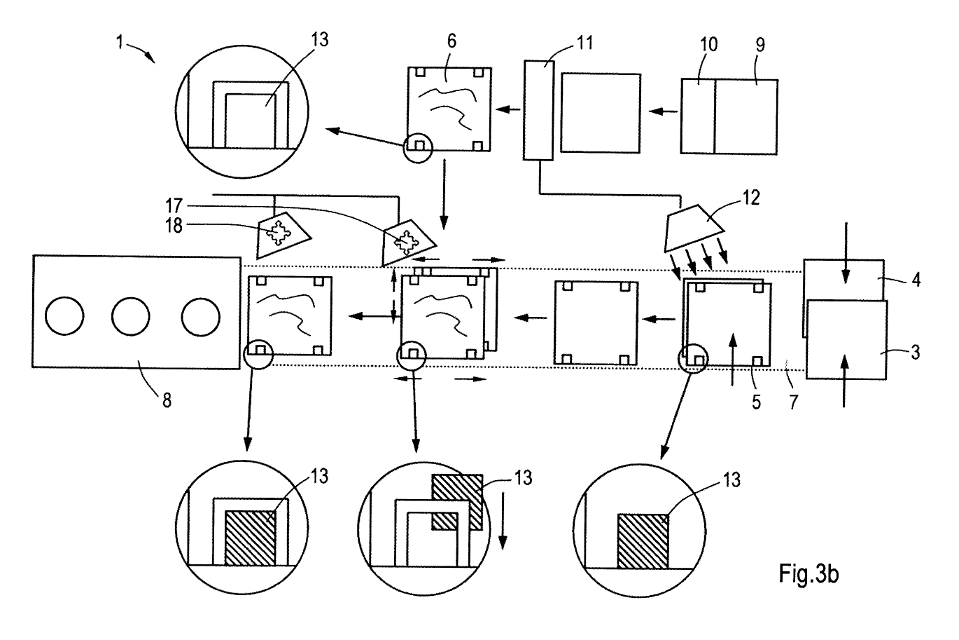

For certain purposes the apparatus 1 may be provided with an adjusting system 17 separate from or part of the sheet handling machine for adjusting the positions of the decoration layer 5 and/or the overlay 6 with respect to each other before they enter the press 8, see FIGS. 3a and 3b. The adjusting system 17 may be separate from or be part of the sheet handling machine, for example but not limited to being a robotic positioner. If desired, part or all of the adjusting system 17 can reside in the support mechanism for the support panel 3 such as a movable platen. This may be desired in case of a relationship between the finishing decoration pattern and the basic decoration pattern. Furthermore, there may be a further adjusting system 18 for adjusting the positions of the decoration layer 5 and/or the overlay 6 before they enter the press 8, which may be desired in case of embossed pressing in the press 8. In the latter case the location of the decoration layer 5 and/or the overlay 6 between press plates should correspond to a relief of one of the press plates. The way of adjusting the positions of the decoration layer 5 and the overlay 6 by using position markers 13 is illustrated in FIG. 3b. Of course, the position markers 13 on the decoration layer 5 and/or the overlay 6 can also be printed by a digital printer. The adjusting system 18 can comprise a positioner, movable platen, etc. for instance as described above with respect to adjusting system 17.

In practice, cameras are applied for controlling the positioning of the position markers 13 via the adjusting system(s).

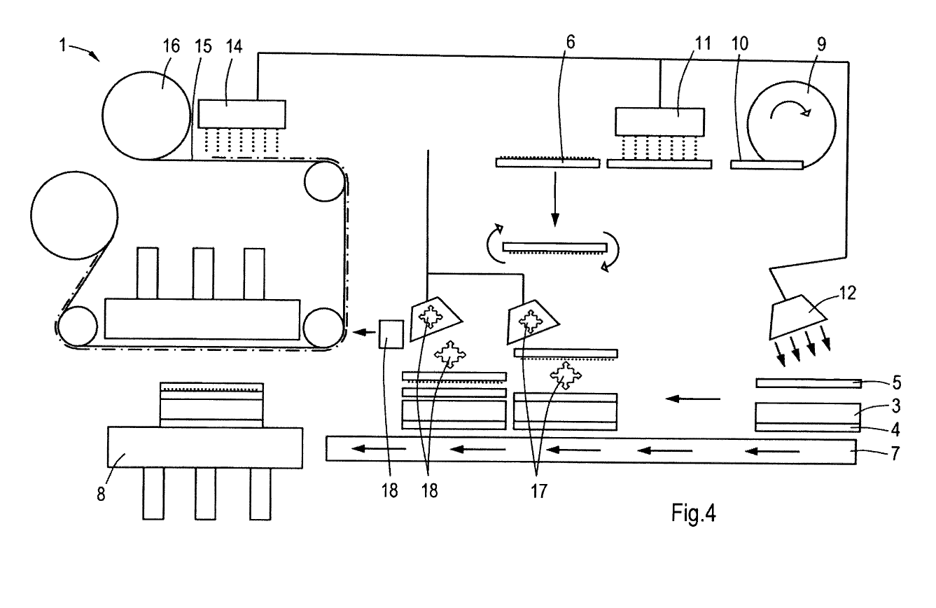

FIG. 4 shows an alternative embodiment of the apparatus 1. This embodiment comprises a second digital printer 14 for printing a curable liquid on a carrier 15. The carrier 15 may be a flexible material, for example a plastic, and the curable liquid may be a plastic which becomes rather rigid after curing, for example a plastic-containing ink, PVC, polyurethane, acrylate, nylon, fluorpolymer, rubber or the like. The curable liquid may be printed in a predetermined pattern, possibly having a relationship with the finishing decoration pattern of the overlay 6 and/or the basic decoration pattern of the decoration layer 5. After curing of the liquid an embossed pattern on the carrier 15 is obtained. The carrier 15 is provided by a roller 16 and guidable along a press plate of the press 8. In this case the press plates may have flat surfaces.

In the embodiment as shown in FIG. 4, the second digital printer 14 is in communication with the detection apparatus 12. On the basis of the information from the detection apparatus 12, an embossing pattern corresponding to the basic decoration pattern of the decoration layer 5 is printed on the carrier 15. The embossing decoration pattern of the carrier 15 is pressed on the overlay 6 such that the upper side of the laminate panel 2 obtains an embossed surface. The embodiment may create such a structure that varying gloss regions appear on the panel 2, for example. This eliminates the necessity of using gloss lacquers.

Drying and curing of the liquid can be achieved by electro-beaming, UV radiation, infrared radiation, hot air, or the like. It is also possible to print position markers on the carrier 15 so as to be able to position the carrier 15 with respect to the overlay correctly. In order to control the positioning a further detection apparatus 18 is present, as shown in FIG. 4.

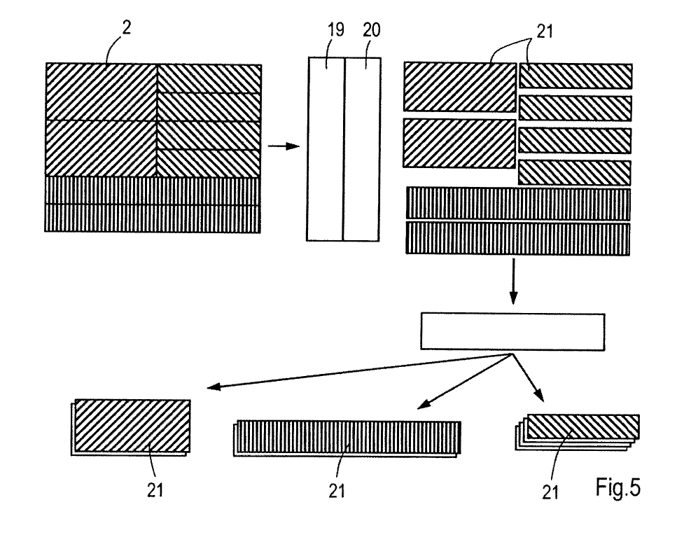

The apparatus 1 can be further extended by using the information from a panel detection apparatus 19 for controlling a saw 20 to cut the finished laminate panel 2 into smaller pieces 21 as illustrated in FIG. 5. The panel detection apparatus 19 observes different pattern regions on the panel 2 and the saw 20 can be controlled such that corresponding panel pieces 21 are cut. In a further step the pieces 21 of similar dimensions can be gathered and packaged.

From the foregoing, it will be clear that aspects of the invention provide an efficient method of manufacturing a laminate panel. The necessity of keeping layers having a decoration pattern and a variety of fixed pressing drums in stock can be eliminated.

The invention is not limited to the embodiments shown in the figures, which can be varied in several ways within the scope of the invention. It is for example possible that the decoration layer is omitted and the basic decoration pattern is directly printed on the support panel, even by digital printing. It is also possible to print the basic decoration pattern on the decoration layer by a digital printer.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

What is claimed is:

1. A method of manufacturing a laminate panel, comprising:
providing a support panel having at least one side to be decorated;
applying an overlay on said at least one side of the support panel; and
printing a finishing decoration pattern on the support panel and/or the overlay by a printing device which is substantially free of contact with the support panel and/or the overlay, respectively.

2. The method of manufacturing a laminate panel according to claim 1, wherein the printing device comprises a digital printer.

3. The method of manufacturing a laminate panel according to claim 1, wherein printing comprises printing the finishing decoration pattern on the overlay, and the method further comprises impregnating the overlay with a resin before or after printing.

4. The method of manufacturing a laminate panel according to claim 1 and further comprising applying a basic decoration pattern on the support panel, the basic decoration pattern being different from the finishing decoration pattern.

5. The method of manufacturing a laminate panel according to claim 4, wherein applying the basic decoration pattern comprises applying the basic decoration panel on a decoration layer which is applied on said at least one side of the support panel to be decorated.

6. The method of manufacturing a laminate panel according to claim 4, wherein the finishing decoration pattern to be printed on the overlay is selected on the basis of the basic decoration pattern which is detected by a detector) before printing the finishing decoration pattern on the overlay.

7. The method of manufacturing a laminate panel according to claim 1 and further comprising printing a predetermined pattern on a carrier with curable liquid so as to form an embossing decoration pattern on the carrier, and pressing the embossing decoration pattern of the carrier on the overlay at said at least one side of the support panel to be decorated for creating an embossed surface thereon.

8. The method of manufacturing a laminate panel according to claim 7, wherein the carrier is provided from a roller and guidable along a press plate.

9. An apparatus for manufacturing a laminate panel (2) by a method according to claim 1.

10. A laminate panel manufactured by a method according to claim 1.
